(19) United States
(12) Patent Application Publication
(10) Pub. No.: US 2006/0248255 A1
(43) Pub. Date: Nov. 2, 2006

(54) Interface Circuit For A Central Processing Unit

(76) Inventors: Wen-Chuan Hsiao, Taipei City (TW); Jen-Shian Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,202

(22) Filed: Jun. 13, 2005

(30) Foreign Application Priority Data
Apr. 29, 2005 (TW) 094113894

(51) Int. Cl. G06F 13/40

(52) U.S. Cl. 710/307

(57) ABSTRACT

An interface circuit for a central processing unit includes a CPU card, a slot for receiving the CPU card, and a graphics card interface coupled to the slot for transmitting signals provided by the slot to a graphics card. The CPU card includes a plurality of input and output pins for exchanging signals, a CPU slot for insertion of a CPU, a memory slot for insertion of a memory, and a north bridge circuit.

### BACKGROUND OF THE INVENTION

1. Field of the Invention

The present invention relates to an interface circuit for insertion of a CPU, and more particularly, to an interface circuit having CPU interfaces, which are plugged into the interface circuit.

2. Description of the Prior Art

A central processing unit (CPU) is one of the most important factors affecting the efficiency of a computer system. These days, the CPUs produced by Intel and Advanced Micro Device (AMD) dominate the market. However, since the Intel Pentium II entered the market, interfaces of a variety of CPUs produced by manufacturers are no longer compatible. In the years of the 486 and 586, AMD, Intel, and Cyrix chips all supported the same CPU interface (CPU slot), so it was very convenient for a user to change to a CPU of another brand.

However, these days CPUs produced by different manufacturers not only require different interfaces (slots), the chipsets functioning together with the CPUs also differ from one another even when the CPUs are produced by the same manufacturer. For example, the interfaces of CPUs produced by Intel include Socket 478, Socket 604, Socket 775, etc., and the interfaces of CPUs produced by AMD include Socket A, Socket 754, Socket 939, Socket 940, etc.

In computer systems, signals transmitted by CPUs of different brands have a variety of formats, so north bridge circuits functioning together with the CPUs have to be different from one another. Therefore, CPUs of different brands or different types not only require different interfaces, chipsets supporting these CPUs differ from one another. Therefore, if the CPU is changed, the motherboard has to be changed accordingly. This wastes resources and increases the burden to consumers.

Therefore, if a common interface and a corresponding interface card for CPUs are provided, a user can make use of the interface to install a variety of CPUs on a motherboard. Thus, resource consumption is reduced and the burden on the user is eased accordingly.

### SUMMARY OF THE INVENTION

It is therefore a primary objective of the claimed invention to provide an interface circuit for insertion of a CPU.

The interface circuit includes a CPU interface card, a slot, and, a graphics card interface coupled to the slot for transmitting signals provided from the slot to a graphics card. The CPU interface card includes a plurality of input and output pins for exchanging signals, a CPU slot for insertion of a CPU, a memory slot for insertion of a memory, and a north bridge circuit. The slot corresponds to the input and output pins for insertion of the CPU interface card.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a CPU interface card of an interface circuit of an embodiment according to the present invention.

FIG. 2 is a schematic diagram of a slot of the interface circuit on a motherboard according to the present invention.

### DETAILED DESCRIPTION

An interface circuit of the present invention allows replacement of CPUs corresponding to a variety of CPU interfaces through a plugging-in process of the interface circuit to a motherboard. The interface circuit comprises a CPU interface card, a graphics card interface and a motherboard slot corresponding to the CPU interface card, wherein the CPU interface card is preferably of a PCI-E x16 format.

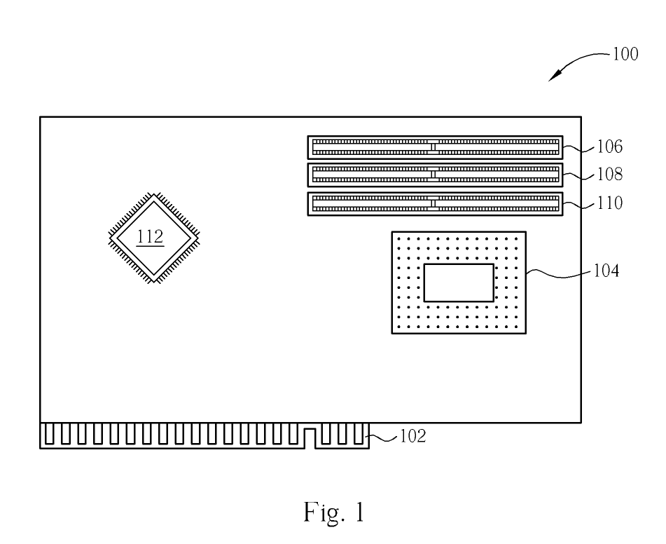

Please refer to FIG. 1, which is a schematic diagram of a CPU interface card 100 of an embodiment according to the present invention. The CPU interface card 100 comprises gold fingers 102, a CPU slot 104, memory slots 106, 108, 110 and a north bridge circuit 112. The gold fingers 102 comprise a plurality of input and output pins for transmitting signals. The gold fingers 102 comply with an enhanced peripheral component interconnect (PCI-E) format. The CPU slot 104 is installed for insertion of a CPU. The memory slots 106, 108, 110 are installed for insertion of memory. The north bridge circuit 112, which complies with an interface format of the CPU slot 104, processes high speed communications between system processors, graphics sub-systems, memory, and PCI buses. For example, if the CPU slot 104 is a Socket 775 (LGA775) interface, the north bridge circuit 112 is a north bridge chipset (for example SIS® 656/656FX, Intel® 915G, etc.) corresponding to Socket 775. Likewise, if the CPU slot 104 is a Socket 939 interface, the north bridge circuit 112 is another north bridge chipset (for example SIS® 756, VIA® K8T800 Pro, etc.) corresponding to Socket 939. Therefore, according to different CPU slots 104, the present invention can provide a plurality of CPU interface cards, each of which has the same gold finger arrangement. Therefore, different CPU interface cards can be inserted into an identical slot device, and thereby different central processing units can be used, so as to reduce resource consumption and ease the burden on a user.

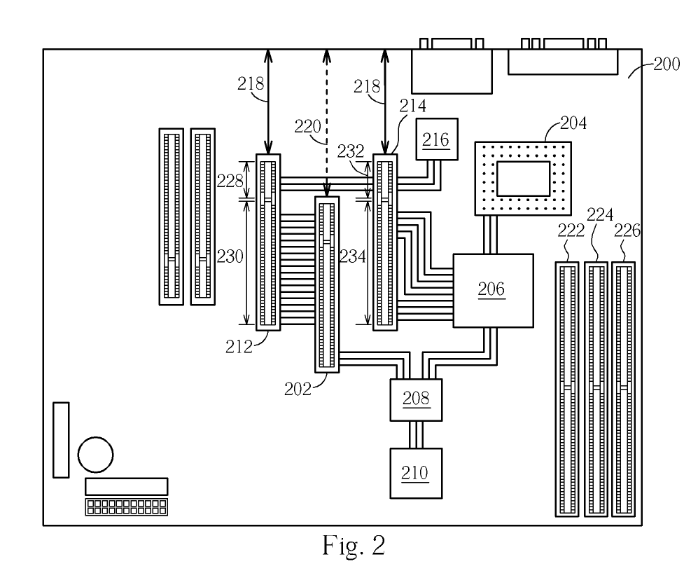

Please refer to FIG. 2, which is a schematic diagram of a slot of an interface circuit on a motherboard 200 according to the present invention. In FIG. 2, a slot 202 is installed for insertion of the CPU interface card 100 shown in FIG. 1, and a slot 212 is coupled to a graphics card interface of the slot 202. The graphics card interface processes video data output from an interface card inserted into the slot 202 and outputs video signals. Additionally, in the motherboard 200, a CPU slot is installed for insertion of a CPU, a north bridge circuit 206 functions together with a chipset of the CPU slot 204, and a slot 214 and memory slots 222, 224, 226 correspond to the graphics card interface and memory interfaces of the CPU slot 204 respectively. That is to say, the CPU slot 204 is pre-installed on the motherboard 200. When a user inserts a CPU complying with the CPU slot 204 into the CPU slot 204, the computer system executes corresponding computer functions with the north bridge circuit 206, the memory slots 222, 224, 226, and the slot 214. Moreover, in the motherboard 200 of the present invention, the slot 202 supports an expansion function of a CPU. That is, when a CPU does not comply with the format of the CPU slot 204, a user can insert the CPU into its corresponding interface card (for example the CPU interface card 100 shown in FIG. 1), and connect the interface card with the motherboard 200 through the slot 202. Therefore, the objective of installing a variety of CPUs on an identical motherboard is realized.

In FIG. 2, the slots 202, 212, 214 are all of a PCI-E interface format. Moreover, a selection circuit 208 of the motherboard 200 is installed to couple signals of a north bridge circuit having a CPU installed to a south bridge circuit 210, which is installed to process input and output functions (for example data exchange of hard disks, external devices) of the system. When an interface card (for example the CPU interface card 100 shown in FIG. 1) having a CPU inserted therein is inserted into the slot 202, the selection circuit 208 couples signals of a north bridge circuit (for example the north bridge circuit 112 of the CPU interface card 100 shown in FIG. 1) on the CPU interface card through the slot to the south bridge circuit 210 of the motherboard 200. On the contrary, when a CPU is inserted into the CPU slot 204, the selection circuit 208 couples the north bridge circuit 206 to the south bridge circuit 210. Therefore, the motherboard 200, even with different CPUs inserted, can still function normally.

Moreover, note in the motherboard 200 the position of the slot 202. In FIG. 2, a length 220 indicates the distance between the slot 202 and an edge of the motherboard 200, and another length 218 indicates another distance between the slot 212 and the edge. The length 220 is longer than the length 218. This indicates that the slot 202 is installed in a position lower than the slots 212 and 214. The reason why the slot 202 is installed lower than the slots 212 and 214 is explained as follows. In the motherboard 200, the slots 212 and 214 are both used for engaging with graphics cards, and receive power output from a power supply 216 through upper gold fingers 228, 232, while the slot 202 is used for engaging with a CPU interface card. The way for the slot 202 to receive power is different from that for the slots 212 and 214. Moreover, graphics cards in the slots 212 and 214 receive video data through lower gold fingers 230, 234. Therefore, the layout between the slot 202 and the slot 212 is designed to be straight to ease signal attenuation and reduce production cost. Moreover, the slot 202 has to further couple to the selection circuit 208, and the slot 202 being lower than the slots 212 and 214 reduces the difficulty in designing the layout between the slot 202 and the selection circuit 208. Thus, the signal attenuation is eased, and the transmission efficiency is increased. On the other hand, the horizontal position of the slot 202 being different from the horizontal position of the slots 212 and 214 prevents a user from erroneously inserting a CPU interface card into slots 214 and 212, or inserting a graphics card into the slot 202, so as to provide a foolproof system.

Therefore, the present invention provides an interface circuit allowing use of different central processing units in a motherboard. A user can, depending on his/her need, select a proper CPU interface card and insert it into a slot on the motherboard. Moreover, in the present invention, because the horizontal position of the slot for a CPU interface card is different from that of another slot for a graphics card, a foolproof system is realized. The present invention also reduces production cost and signal attenuation, and increases transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interface circuit comprising:
a CPU interface card comprising:
a plurality of input and output pins for exchanging signals;
a CPU slot for insertion of a CPU;
a memory slot for insertion of a memory card; and
a north bridge circuit;
a slot corresponding to the input and output pins for insertion of the CPU interface card; and
a graphics card interface coupled to the slot for transmitting signals provided from the slot to a graphics card.

2. The interface circuit of claim 1, wherein the slot is of an enhanced peripheral component interconnect (PCI-E) format.

3. The interface circuit of claim 1, wherein the graphics card interface is of a PCI-E format.

4. The interface circuit of claim 1, wherein the slot is offset from the graphics card interface in horizontal position.

5. The interface circuit of claim 1, wherein the slot is further coupled to a switch circuit for coupling the CPU interface card to a motherboard when the CPU is inserted into the CPU slot.
